(19) United States
(12) Patent Application Publication
(10) Pub. No.: US 2026/0212582 A1
(43) Pub. Date: Jul. 23, 2026

(54) TILE-BASED RASTERIZATION METHOD AND DEVICE, AND IMAGE RENDERING METHOD AND DEVICE

(71) Applicant: MOORE THREADS TECHNOLOGY CO., LTD., Beijing (CN)

(72) Inventors: Tong SUN, Beijing (CN); Yubo ZHANG, Beijing (CN)

(21) Appl. No.: 19/158,185

(22) PCT Filed: Feb. 5, 2024
(86) PCT No.: PCT/CN2024/076052

§ 371 Date: Aug. 20, 2025

(30) Foreign Application Priority Data
Feb. 20, 2023 (CN) 202310136026.8

(51) Int. Cl. G06T 15/00; G06T 1/20

(52) U.S. Cl. CPC G06T 15/005; G06T 1/20

(57) ABSTRACT

The present disclosure provides a tile-based rasterization method and device, and an image rendering method and device. The rasterization method includes: partitioning a tile into a plurality of first sub-tiles; determining whether each first sub-tile is covered by a primitive; in response to the first sub-tile being covered by the primitive, rasterizing the primitive by using pixels in the first sub-tile covered by the primitive as a mapping object, to determine a first mask for each sample of each pixel in the first sub-tile covered by the primitive; combining first sub-tiles for which first masks of samples of pixels have been determined to form a rasterized tile; and determining pixel quad data based on the rasterized tile, wherein the pixel quad data includes the first mask.

### CROSS-REFERENCE TO RELATED APPLICATION

This disclosure is based on, and claims priority to Chinese Patent Application No. 202310136026.8, filed on Feb. 20, 2023, the disclosure of which is hereby incorporated by reference in its entirety.

### TECHNICAL FIELD

The present disclosure relates to a tile-based rasterization method and device, and an image rendering method and device.

### BACKGROUND

The image rendering requires a significant amount of memory bandwidth. Compared with a desktop-level Graphics Processing Unit (GPU), a mobile-level GPU not only has limited available memory bandwidth, but also generally uses the memory with low-power and narrow-bandwidth. Therefore, the bandwidth of mobile-level GPU brings the limitation on the image rendering. How to improve the GPU performance and the image quality with the minimal bandwidth requirement as possible is an urgent problem to be solved in the art.

### SUMMARY

The present disclosure provides a tile-based rasterization method and device, and an image rendering method and device.

According to an aspect of the present disclosure, a tile-based rasterization method is provided. The method includes: partitioning a tile into a plurality of first sub-tiles, herein the tile is obtained by partitioning a screen space for displaying an image of a scene to be rendered; determining whether each of the plurality of first sub-tiles is covered by a primitive, herein the primitive is obtained by performing vertex processing on the scene to be rendered; in response to the first sub-tile being covered by the primitive, rasterizing the primitive by using pixels in the first sub-tile covered by the primitive as a mapping object to determine a first mask for each sample of each pixel of the first sub-tile covered by the primitive; combining first sub-tiles for which first masks of samples of pixels have been determined to form a rasterized tile; and determining pixel quad data based on the rasterized tile, wherein the pixel quad data includes the first mask.

In some embodiments, determining the pixel quad data based on the rasterized tile includes: determining a number of color data stored for a pixel and a number of samples of the pixel; and in response to the number of color data stored for the pixel being less than the number of samples of the pixel, partitioning the rasterized tile into a plurality of second sub-tiles based on a capacity of an on-chip color buffer of a graphics processor; and extracting the pixel quad data from data information of the second sub-tiles.

In some embodiments, determining the pixel quad data based on the rasterized tile further includes: in response to the number of color data stored for the pixel being equal to the number of samples of the pixel, extracting the pixel quad data from data information of the first sub-tiles.

In some embodiments, partitioning the rasterized tile into the plurality of second sub-tiles based on the capacity of the on-chip color buffer of the graphics processor includes: determining a preset size of the second sub-tiles based on the capacity of the on-chip color buffer of the graphics processor; and obtaining the second sub-tiles on the rasterized tile along a row direction and a column direction according to the preset size of the second sub-tiles.

In some embodiments, the on-chip color buffer includes a plurality of banks, and partitioning the rasterized tile into the plurality of second sub-tiles based on the capacity of the on-chip color buffer of the graphics processor further includes: determining whether an actual size of a second sub-tile at an edge of the row and/or the column is less than or equal to one-half of the preset size; and in response to the actual size of the second sub-tile at the edge being less than or equal to one-half of the preset size, storing at least two second sub-tiles at the edge in a single bank.

In some embodiments, determining whether each of the plurality of first sub-tiles is covered by the primitive includes: determining a vertical coordinate range of a minimum peripheral rectangular box surrounding the primitive; determining, row by row, whether a vertical coordinate range of each row of first sub-tiles at least partially overlaps with the vertical coordinate range of the minimum peripheral rectangular box; and in response to a vertical coordinate range of a row of first sub-tiles does not at least partially overlap with the vertical coordinate range of the minimum peripheral rectangular box, determining that first sub-tiles in the row of first sub-tiles are not covered by the primitive.

In some embodiments, determining whether each of the plurality of first sub-tiles is covered by the primitive further includes: determining a horizontal coordinate range of the minimum peripheral rectangular box surrounding the primitive; in response to a vertical coordinate range of a row of first sub-tiles at least partially overlaps with the vertical coordinate range of the minimum peripheral rectangular box, determining, one by one, whether a horizontal coordinate range of each first sub-tile in the row of first sub-tiles at least partially overlaps with the horizontal coordinate range of the minimum peripheral rectangular box; and in response to the horizontal coordinate range of the first sub-tile in the row of first sub-tiles does not at least partially overlap with the horizontal coordinate range of the minimum peripheral rectangular box, determining that the first sub-tile is not covered by the primitive.

In some embodiments, determining whether each of the plurality of first sub-tiles is covered by the primitive includes: determining whether a region defined by vertex coordinates of the primitive at least partially overlaps with a region defined by a horizontal coordinate range and a vertical coordinate range of a first sub-tile; and in response to the region defined by the vertex coordinates of the primitive at least partially overlaps with the region defined by the horizontal coordinate range and the vertical coordinate range of the first sub-tile, determining that the first sub-tile is covered by the primitive.

In some other embodiments, determining whether each first sub-tile is covered by the primitive includes: sampling sub-tile samples of a first sub-tile to determine a second mask of the first sub-tile; and determining whether the first sub-tile is covered by the primitive based on the second mask of the first sub-tile.

In some embodiments, the method further includes: in response to the first sub-tile being not covered by the primitive, assigning a preset first mask to samples of pixels of the first sub-tile.

According to another aspect of the present disclosure, an image rendering method is provided. The image rendering method includes: performing vertex processing on a scene to be rendered to obtain primitive data of the scene to be rendered; partitioning a screen space for displaying an image of the scene to be rendered to obtain tile data; determining a primitive list for respective tiles based on the primitive data and the tile data; performing the tile-based rasterization method of any one of embodiments of the present disclosure on each tile based on the primitive list to obtain the pixel quad data; determining a sample coverage ratio of a pixel based on the pixel quad data; storing a first number of color data for the pixel based on the sample coverage ratio, herein a number of samples of the pixel is a second number, and the first number and the second number are set independently; storing color data for pixels of each tile into a system memory; and merging the color data of respective tiles in the system memory to obtain a rendered image.

In some embodiments, performing vertex processing on the scene to be rendered to obtain the primitive data of the scene to be rendered includes: determining a vertex coordinate of an object in the scene to be rendered; transforming the vertex coordinate from an object-based coordinate system to a coordinate system based on a world space or a normalized device coordinate space to obtain a transformed vertex coordinate; and determining the primitive data based on the transformed vertex coordinate.

According to another aspect of the present disclosure, a tile-based rasterization device is provided. The rasterization device includes: a tile parser, configured to partition a tile into a plurality of first sub-tiles, herein the tile is obtained by partitioning a screen space for displaying an image of a scene to be rendered; a sub-tile rasterizer, configured to determine whether each of the plurality of first sub-tiles is covered by a primitive, herein the primitive is obtained by performing vertex processing on the scene to be rendered; a sample rasterizer, configured to in response to the first sub-tile being covered by the primitive, rasterize the primitive by using pixels in the first sub-tile covered by the primitive as a mapping object to determine a first mask for each sample of each pixel of the first sub-tile covered by the primitive; a tile recombiner, configured to combine first sub-tiles for which first masks of samples of pixels have been determined to form a rasterized tile; and a pixel quad generator, configured to determine pixel quad data based on the rasterized tile, herein the pixel quad data includes the first mask.

In some embodiments, the pixel quad generator includes a tile repartitioner and a pixel quad packer. The tile repartitioner is configured to: determine a number of color data stored for a pixel and a number of samples of the pixel; and in response to the number of color data stored for the pixel being less than the number of samples of the pixel, partition the rasterized tile into a plurality of second sub-tiles based on a capacity of an on-chip color buffer of a graphics processor; and the pixel quad packer is configured to extract the pixel quad data from data information of the second sub-tiles.

In some embodiments, the tile repartitioner is further configured to: in response to the number of color data stored for the pixel being equal to the number of samples of the pixel, extract the pixel quad data from data information of the first sub-tiles.

In some embodiments, the tile repartitioner, which is configured to partition the rasterized tile into the plurality of second sub-tiles based on the capacity of the on-chip color buffer of the graphics processor, is further configured to: determine a preset size of the second sub-tiles based on the capacity of the on-chip color buffer of the graphics processor; and obtain the second sub-tiles on the rasterized tile along a row direction and a column direction according to the preset size of the second sub-tiles.

In some embodiments, the on-chip color buffer includes a plurality of banks, and the tile repartitioner, which is configured to partition the rasterized tile into the plurality of second sub-tiles based on the capacity of the on-chip color buffer of the graphics processor, is further configured to: determine whether an actual size of a second sub-tile at an edge of the row and/or the column is less than or equal to one-half of the preset size; and in response to the actual size of the second sub-tile at the edge being less than or equal to one-half of the preset size, store at least two second sub-tiles at the edge in a single bank.

In some embodiments, the sub-tile rasterizer, which is configured to determine whether each of the plurality of first sub-tiles is covered by the primitive, is further configured to: determine a vertical coordinate range of a minimum peripheral rectangular box surrounding the primitive; determine, row by row, whether a vertical coordinate range of each row of first sub-tiles at least partially overlaps with the vertical coordinate range of the minimum peripheral rectangular box; and in response to a vertical coordinate range of a row of first sub-tiles does not at least partially overlap with the vertical coordinate range of the minimum peripheral rectangular box, determine that first sub-tiles in the row of first sub-tiles are not covered by the primitive.

In some embodiments, the sub-tile rasterizer, which is configured to determine whether each of the plurality of first sub-tiles is covered by the primitive, is further configured to: determine a horizontal coordinate range of the minimum peripheral rectangular box surrounding the primitive; in response to a vertical coordinate range of a row of first sub-tiles at least partially overlaps with the vertical coordinate range of the minimum peripheral rectangular box, determine, one by one, whether a horizontal coordinate range of each first sub-tile in the row of first sub-tiles at least partially overlaps with the horizontal coordinate range of the minimum peripheral rectangular box; and in response to the horizontal coordinate range of the first sub-tile in the row of first sub-tiles does not at least partially overlap with the horizontal coordinate range of the minimum peripheral rectangular box, determine that the first sub-tile is not covered by the primitive.

In some embodiments, the sub-tile rasterizer, which is configured to determine whether each of the plurality of first sub-tiles is covered by the primitive, is further configured to: determine whether a region defined by vertex coordinates of the primitive at least partially overlaps with a region defined by a horizontal coordinate range and a vertical coordinate range of a first sub-tile; and in response to the region defined by the vertex coordinates of the primitive at least partially overlaps with the region defined by the horizontal coordinate range and the vertical coordinate range of the first sub-tile, determine that the first sub-tile is covered by the primitive.

In some embodiments, the sub-tile rasterizer, which is configured to determine whether each first sub-tile is covered by the primitive, is further configured to: sample sub-tile samples of a first sub-tile to determine a second mask of the first sub-tile; and determine whether the first sub-tile is covered by the primitive based on the second mask of the first sub-tile.

In some embodiments, the sub-tile rasterizer is further configured to: in response to the first sub-tile being not covered by the primitive, assign a preset first mask to samples of pixels of the first sub-tile.

According to another aspect of the present disclosure, it is further provided an image rendering device. The image rendering device includes: a vertex processor, configured to perform vertex processing on a scene to be rendered to obtain primitive data of the scene to be rendered; a tile partitioner, configured to: partition a screen space for displaying an image of the scene to be rendered to obtain tile data; and determine a primitive list for respective tiles based on the primitive data and the tile data; the tile-based rasterization device according to any one of embodiments in the present disclosure, the rasterization device is configured to determine the pixel quad data based on the primitive list; a pixel processor, configured to: determine a sample coverage ratio of a pixel based on the pixel quad data; store a first number of color data for the pixel based on the sample coverage ratio; and store color data for pixels of each tile into a system memory; herein a number of samples of the pixel is a second number, and the first number and the second number are set independently; and an output merger, configured to merge the color data of respective tiles in the system memory to obtain a rendered image.

In some embodiments, the vertex processor is further configured to: determine a vertex coordinate of an object in the scene to be rendered; transform the vertex coordinate from an object-based coordinate system to a coordinate system based on a world space or a normalized device coordinate space to obtain a transformed vertex coordinate; and determine the primitive data based on the transformed vertex coordinate.

### BRIEF DESCRIPTION OF THE DRAWINGS

The above and other aspects, objects, and features of the concepts of present disclosure will become more apparent according to the exemplary embodiments of the concepts of present disclosure illustrated in detail with reference to the accompanying drawings. In the accompanying drawings,

FIG. 1 schematically illustrates a block diagram of a related tile-based rendering pipeline;

FIG. 2 schematically illustrates a screen space after tile partitioning;

FIG. 3 schematically illustrates a process of forming a displayed image from the result of rendering block-by-block;

FIG. 4 illustrates an architecture of a system-on-chip in which methods of the embodiments of the present disclosure may be implemented;

FIG. 5 schematically illustrates a flowchart of a tile-based rasterization method according to an embodiment of the present disclosure;

FIG. 6 schematically illustrates a pipeline block diagram of a tile-based rasterization method according to an embodiment of the present disclosure;

FIG. 7 schematically illustrates a process from the tile to the pixel quad according to an embodiment of the present disclosure;

FIG. 8 schematically illustrates a flowchart of a tile-based rasterization method according to an embodiment of the present disclosure;

FIG. 9 schematically illustrates a process from the tile to the pixel quad according to an embodiment of the present disclosure;

FIG. 10 schematically illustrates a process of partitioning the rasterized tile into the second sub-tiles and storing the second sub-tiles to an on-chip buffer;

FIG. 11 schematically illustrates a flow chart of an image rendering method according to an embodiment of the present disclosure.

FIG. 12 schematically illustrates a block diagram of a tile-based rasterization device according to an embodiment of the present disclosure;

FIG. 13 schematically illustrates a block diagram of an image rendering device according to an embodiment of the present disclosure.

### DETAILED DESCRIPTION

In order to enable the above objects, features and advantages of the present disclosure to be more apparent and understandable, the specific embodiments of the present disclosure will be described in detail below with reference to the accompanying drawings.

Many specific details are described in the following description to facilitate a full understanding of the present disclosure. However, the present disclosure may also be implemented in other ways than those described herein, and thus the present disclosure is not limited by the specific embodiments disclosed below.

The following detailed description is provided to facilitate the understanding of the methods and devices described herein. However, various changes, modifications, and substitutions of the methods and devices described herein will be apparent to those of ordinary skill in the art upon understanding the present disclosure. The order of operations described in the present disclosure is merely an example, and the order of operations other than those that must be performed in a specific order is not limited to the order as described herein. The reasonable changes in these orders will be apparent to those of ordinary skill in the art. In addition, the features described herein may be implemented in different forms and should not be construed as being limited by the examples described herein. Further, the description for the functions and structures well known to those of ordinary skill in the art may be omitted for the sake of more clarity and conciseness.

In the accompanying drawings and the detailed description, only part of the described embodiments are illustrated. However, it is to be understood that the embodiments of the present disclosure should not be construed as limited to the illustrated form. Also, the scope of the present disclosure also includes all changes, equivalents, or alternatives to the described embodiments. The flowchart is used in the present disclosure to illustrate the operations performed by the system according to the embodiments of the present disclosure. It is to be understood that the preceding or following operations are not necessarily performed precisely in order. Instead, the various steps may be processed in a reverse order or simultaneously. Alternatively, other operations are added to these processes, or one or more steps are removed from these processes.

As mentioned above, the mobile-level GPU aims to improve the GPU performance and the image quality in a case of small bandwidth. One possible implementation is to make improvements to the rendering method. In the related technologies, Tile Based Rendering (TBR) architecture may be used. Its main feature is that the screen space to be rendered is partitioned into tiles, and the coordinate of each tile is stored in the system memory in the form of a list through the intermediate buffer. During the rendering, the tiles are loaded into the on-chip memory of the GPU tile by tile, and the data required for the rendering may be obtained from the on-chip memory, such that the slow interactive processing with the system memory is avoid. After each tile is rendered, the result is output to the corresponding region in the Frame Buffer of the system memory. After all the tiles are rendered, the data in the frame buffer is the data of the entire image to be displayed. The advantage of this rendering method is that the processing is performed with the unit of tile with smaller size, to make use of the on-chip memory with small capacity but faster read and write speed, such that the frequent interaction between the GPU and the system memory is reduced, and the power consumption and bandwidth are reduced. However, this rendering method requires the use of on-chip memory as the intermediate buffer.

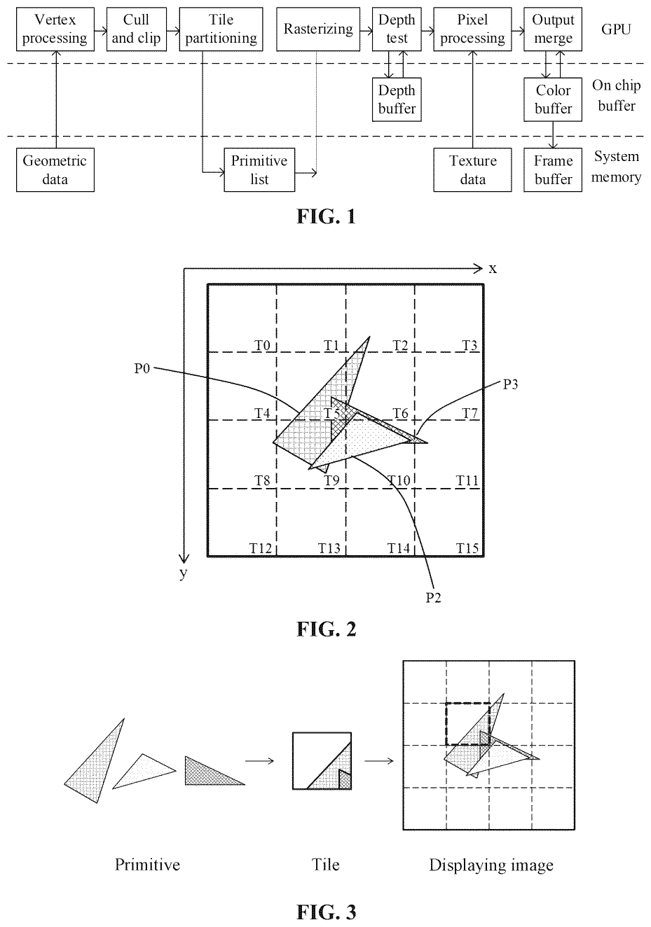

FIG. 1 schematically illustrates a block diagram of a related tile-based rendering pipeline. A tile-based rendering pipeline includes a front end and a back end. As illustrated in FIG. 1, the front end mainly includes performing the transformation for the vertex and the primitive in the vertex process. The term “primitive” denotes a polygon formed by points, lines, or vertices. For example, the primitive may be a triangle formed by connecting the vertices. However, the primitive is not limited to being formed as a triangle. Then, the graphic processing (including clip, cull, etc.) is performed. Next, in the tile partitioning process, the partition of the screen space is completed and the tile to which each primitive belongs is recorded to form the primitive list. FIG. 2 schematically illustrates the screen space after tile partitioning. The primitives P0, P2, P3 should be displayed in the screen space. It is to be understood that although FIG. 2 illustrates that the screen space is partitioned into 4 rows and 4 columns with a total of 16 tiles (T0-T15). However, this partition form and number are merely exemplary. Further, the shape of the tile is not limited to the illustrated rectangular shape. The above primitive list is then written into the system memory.

The back end mainly includes rasterizing the primitive in units of tile. The rasterizing is a process of assigning color to each pixel in the image based on the primitive data. The rasterizing process may perform multi-sampling for each pixel to improve the accuracy of the color assigned to the respective pixel. In the multi-sampling, one pixel includes a plurality of samples, each sample is assigned with the color, and then in the subsequent steps, the color assigned to each sample is used to calculate a single overall color for the respective pixel. Multi-sampling enables the non-vertical and non-horizontal lines in the display screen to be smoother. This smoothing process may also be referred to as antialiasing. However, this multi-sampling method may require additional processing time and resources, which increases the rendering cost. Furthermore, in the related art, the sampling accuracy of rasterizating and the shading accuracy of pixels are strictly bound. For example, the number of samples within a single pixel for the rasterizing is same as the number of times that a single pixel is shaded during the shading phase. This causes the amount of data of the output color to increase with the increase of the sampling rate for the rasterizing, thereby increasing the pressure of the output merge stage. Such a design may adversely affect the overall performance of the GPU rendering pipeline for the two-dimensional (2D) image that does not require high antialiasing effect.

After the rasterizing, the back end further includes calling the depth data in the on-chip depth buffer (such as the Static Random Access Memory (SRAM) of the GPU) to perform depth testing. Next, the operations of texturing and pixel shading are performed to complete the rendering for the tiles. The pixel shading requires calling the color data in the on-chip color buffer. The rendering result for each primitive is saved in the depth buffer and the color buffer. After all primitives in a tile are rendered, the result is output to a frame buffer in the system memory for being used to display the whole image when all tiles have been rendered. FIG. 3 schematically illustrates a process of generating the displayed image from the result of rendering block-by-block. According to the tile-based rendering pipeline, frequently reading/writing the depth data and color data from/to the system memory (such as the Dynamic Random Access Memory (DRAM)) may be avoided.

In the various processes of the pipeline described above, after the primitive list is generated in the tile partitioning process, the primitive list is transmitted from the GPU into the system memory, and it needs to be transmitted from the system memory to the GPU when the rasterizing is performed. GPU's access to the system memory incurs a large bandwidth consumption. This bandwidth consumption is positively related to the number of tiles generated in the tile partitioning process, and the number of tiles has a great influence on the resources bound to the GPU pipeline and the execution ability of the hardware.

The number of tiles is determined by both the size of the screen space and the size of the tiles, while the size of the tiles in turn is limited by the storage space of the on-chip memory (e.g., depth buffer and color buffer). The size of the storage space of the on-chip memory is generally fixed. If the size of tiles is greater, and/or the sampling rate for the tile rasterization is higher, the data of a single tile may not be fitted into the buffer. In some related image rendering methods, in order to meet the requirements of on-chip memory, the size of tiles is reduced. However, it brings some drawbacks. For example, for rendering a same image, the smaller the size of the tiles, the greater the number of partitioned tiles, which will increase the load of modules, such as tile partitioning module, and may cause blockage of the rendering pipeline. Moreover, the greater the number of tiles, the greater the amount of data of the primitive list. Because the primitive list needs to be stored in the system memory for the interaction between the front end and back end, the writing and reading bandwidth of the memory are influenced.

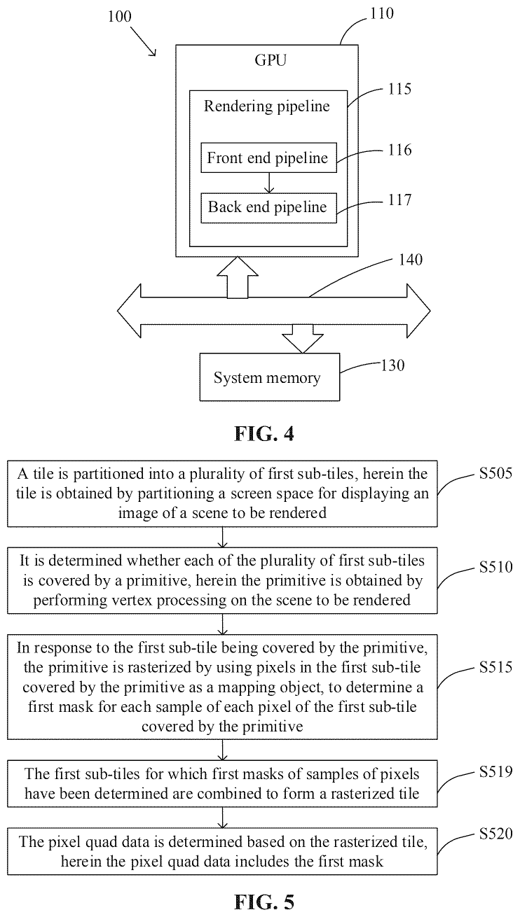

In order to at least solve the above problems, the present disclosure proposes a tile-based rasterization method, which may at least reduce the influence of on-chip buffer on the size of tiles and the sampling rate for rasterizing. FIG. 4 illustrates an architecture of a system on chip (SoC) 100 in which the methods of the embodiments of the present disclosure may be implemented.

As illustrated in FIG. 4, the system on chip 100 includes at least a graphics processing unit (GPU) 110, a system memory 130, and a bus 140. In addition to the components illustrated in FIG. 4, it is to be understood for those skilled in the art that the system on chip 100 may include other general-purpose components.

The GPU 110 may perform tile-based graphic rendering. The term “tile-based” as used herein means that a screen space (e.g., each frame of a video) for displaying the image of a scene to be rendered is partitioned into a plurality of tiles, and the rendering is performed on the basis per-tile. A tile-based rendering architecture may reduce the amount of computation compared to the pixel-based rendering. Therefore, the tile-based rendering architecture is suitable for implementing the graphic rendering method in the device with relatively low processing performance, such as the mobile-level GPU.

As illustrated in FIG. 4, the GPU 110 may perform the rendering pipeline 115. The rendering pipeline 115 includes a front end pipeline 116 and a back end pipeline 117. In an example, the front end pipeline 116 generates a primitive list, which includes the vertex data and the primitive data for the object in the scene to be rendered, in units of tile. The back-end pipeline 117, based on the primitive list generated by the front end pipeline 116, performs rendering process on the basis of per-tile. When the back end pipeline 117 completes rendering, the presentation of the pixels on the screen for the scene to be rendered may be determined.

The system memory 130 may be a hardware element that stores various data processed by the system on chip 100. For example, the system memory 130 may store the data processed by the GPU 110. Further, the system memory 130 may store the applications, drivers, or the like to be driven by the GPU 110. In some embodiments, the system memory 130 may include Read-Only Memory (ROM), Electrically Erasable Programmable Read-Only Memory (EEPROM), Random Access Memory (RAM), Dynamic Random Access Memory (DRAM), Static Random Access Memory (SRAM), flash memory, non-volatile memory, or other devices that are deemed by those of ordinary skill in the art to be suitable and capable of storing and providing instructions or software and any associated data, data files, and data structures to the processor in a non-transitory manner.

The bus 140 may be, for example, the hardware element that connects the hardware elements in the system on chip 100 such that the data is transmitted and received between the hardware elements. The bus 140 may include various suitable types of buses and is not limited unless otherwise specified.

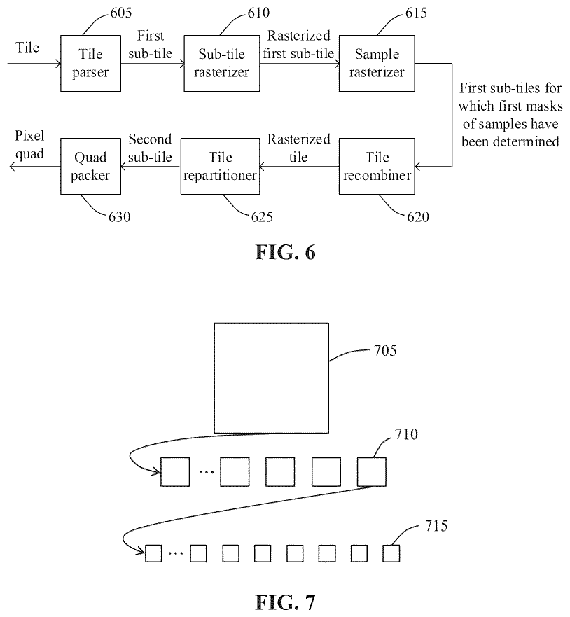

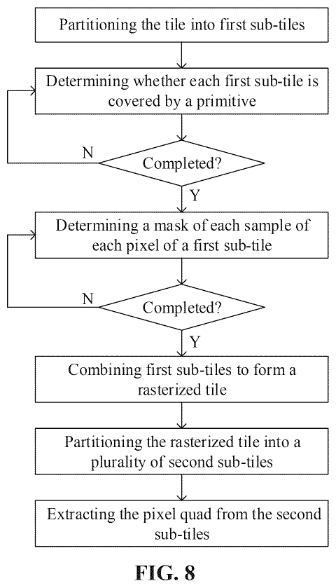

Through the above-described rendering pipeline 115, particularly the back end pipeline 117, the tile-based rasterization method in the embodiments of the present disclosure may be implemented. The method is described below. FIG. 5 schematically illustrates a flowchart of a tile-based rasterization method according to an embodiment of the present disclosure. FIG. 6 schematically illustrates a pipeline block diagram of a tile-based rasterization method according to an embodiment of the present disclosure. As illustrated in FIG. 5, the method includes steps S505 to S520.

At step S505, a tile is partitioned into a plurality of first sub-tiles, herein the tile is obtained by dividing a screen space for displaying an image of a scene to be rendered.

At step S510, it is determined whether each of the plurality of first sub-tiles is covered by a primitive, herein the primitive is obtained by performing vertex processing on the scene to be rendered.

At step S515, in response to the first sub-tile being covered by the primitive, the primitive is rasterized by using pixels in the first sub-tile covered by the primitive as a mapping object, to determine a first mask for each sample of each pixel of the first sub-tile covered by the primitive.

At step S519, the first sub-tiles for which first masks of samples of pixels have been determined are combined to form a rasterized tile.

At step S520, the pixel quad data is determined based on the rasterized tile, herein the pixel quad data includes the first mask.

Before performing the tile-based rasterization method according to the embodiment of the present disclosure, the front end operations of the graphics pipeline, which include, for example, transformation for the vertices and primitives, graphics processing and tile partitioning, have been completed, for example, by the front end pipeline 116. As mentioned above, the tile partitioning is a process of partitioning the screen space for displaying the image of a scene to be rendered to obtain the tiles. After obtaining the tiles, according to the tile-based rasterization method according to the embodiment of the present disclosure, a tile is partitioned into a plurality of first sub-tiles (step S505). The vertex coordinates of each first sub-tile may be obtained together in this process. As illustrated in FIG. 6, in this step, the tile data (e.g., coordinate, size, image information of the tile) is input to a tile parser 605. After receiving the tile data, the tile parser 605 outputs the data of the first sub-tiles, such as the vertex coordinate of each first sub-tile. The obtained size of the first sub-tile may be determined according to the performance of the GPU 110, such as the data throughput.

Then, it is determined whether each first sub-tile is covered by a primitive (step S510). In the front end operation, the primitive has been obtained by vertex processing the scene to be rendered. In this step, the data of the first sub-tiles output by the tile parser is input into the sub-tile rasterizer 610. The sub-tile rasterizer 610 determines whether the sub-tile is covered by the primitive, and such determination may be understood as rasterizing the primitive by using the sub-tile as the mapping object. Such rasterization is performed on each first sub-tile one by one and the rasterized first sub-tile (i.e., the first sub-tile containing the sub-tile mask) is output until the rasterization has been performed on all the first sub-tiles, and then it proceeds to the next step.

The determination of whether each first sub-tile is covered by the primitive may be implemented by following manner. For example, in some embodiments, the determination of whether the first sub-tile is covered by the primitive may be determined based on whether the range of the region occupied by the first sub-tile overlaps with the range of the region occupied by the primitive. For example, the region occupied by the first sub-tile is first defined based on the horizontal coordinate range and vertical coordinate range of the first sub-tile, and the region occupied by the primitive is defined based on the vertex coordinates of the primitive. Then, it is determined whether the two regions at least partially overlap. In response to the region defined by the vertex coordinates of the primitive at least partially overlaps with the region defined by the horizontal coordinate range and the vertical coordinate range of the first sub-tile, it is determined that the first sub-tile is covered by the primitive. In addition, in response to the region defined by the vertex coordinates of the primitive does not at least partially overlap with the region defined by the horizontal coordinate range and the vertical coordinate range of the first sub-tile, it is determined that the first sub-tile is not covered by the primitive. The vertex coordinates of the primitive are determined in the vertex processing operation of the front end pipeline, and the horizontal coordinate range and vertical coordinate range of the first sub-tile may be determined by the tile parser 605 in the above-mentioned step.

In some other embodiments, sampling may be used to determine whether the first sub-tile is covered by a primitive. For example, the samples of a sub-tile are sampled to determine the mask of the first sub-tile, and then it is determined whether the first sub-tile is covered by a primitive based on the mask of the first sub-tile. In the present disclosure, the samples of a pixel are sampled, and the obtained mask may be referred to as a first mask. The samples of the first sub-tile are sampled, and the obtained mask may be referred to as the second mask. In some embodiments, a sample of the sub-tile may be one of the samples of the pixels included in the sub-tile, and at this case, although the sample of the pixel is used for performing sampling, the second mask of the sub-tile is obtained instead of the first mask of the samples of the pixel. In other embodiments, the sample of the sub-tile may also be an independent sample independent of the samples of the pixel.

In some other embodiments, it may be determined whether each first sub-tile is covered by a primitive by comparing the horizontal and vertical coordinate ranges of the first sub-tile with the horizontal and vertical coordinate ranges of the minimum peripheral rectangular box of the primitive. Firstly, a vertical coordinate range of a minimum peripheral rectangular box surrounding the primitive is determined. Then it is determined, row by row, whether a vertical coordinate range of each row of first sub-tiles at least partially overlaps with the vertical coordinate range of the primitive. For example, it is determined row by row whether the maximum value of the vertical coordinate of each row of first sub-tiles is less than the minimum value of the vertical coordinate of the minimum peripheral rectangular box and whether the minimum value of the vertical coordinate of each row of first sub-tiles is greater than the maximum value of the vertical coordinate of the minimum peripheral rectangular box. If the maximum value of the vertical coordinate of a row of first sub-tiles is less than the minimum value of the vertical coordinate of the minimum peripheral rectangular box of the primitive, or if the minimum value of the vertical coordinate of a row of first sub-tiles is greater than the maximum value of the vertical coordinate of the minimum peripheral rectangular box of the primitive, the respective row of first sub-tiles and the primitive do not overlap. At this case, it may be directly determined that each first sub-tile in the respective row of first sub-tiles is not covered by the primitive, and there is no need to compare the vertical coordinate range of the first sub-tile in the row one by one. Therefore, in response to a vertical coordinate range of a row of first sub-tiles does not at least partially overlap with the vertical coordinate range of the minimum peripheral rectangular box, it is determined that first sub-tiles in the row of first sub-tiles are not covered by the primitive. If the vertical coordinate range of a row of first sub-tiles at least partially overlap with the vertical coordinate range of the minimum peripheral rectangular box, it is indicated that the first sub-tiles in the respective row of first sub-tiles may partially overlap with the primitive. At this case, the positional relationship between each first sub-tile in the row of first sub-tiles and the minimum peripheral rectangular box of the primitive may be further compared horizontally to continue detecting whether each first sub-tile in the row of first sub-tiles is covered by the primitive. For example, the horizontal coordinate range of the minimum peripheral rectangle box surrounding the primitive is determined. If the maximum value of the vertical coordinate of a row of first sub-tiles is greater than or equal to the minimum value of the vertical coordinate of the minimum peripheral rectangular box and the minimum value of the vertical coordinate of a row of first sub-tiles is less than or equal to the maximum value of the vertical coordinate of the minimum peripheral rectangular box, it is determined whether the horizontal coordinate range of each first sub-tile in the row of first sub-tiles at least partially overlaps with the range of horizontal coordinate of the minimum peripheral rectangle box one by one. For example, it is determined whether the maximum value of the horizontal coordinate of each first sub-tile in the row of the first sub-tiles is less than the minimum value of the horizontal coordinate of the minimum peripheral rectangle box and whether the minimum value of the horizontal coordinate of each first sub-tile in the row of the first sub-tiles is greater than the maximum value of the horizontal coordinate of the minimum peripheral rectangle box. If the maximum value of the horizontal coordinate of a certain first sub-tile in the respective row of first sub-tiles is less than the minimum value of the horizontal coordinate of the minimum peripheral rectangular box of the primitive, or if the minimum value of the horizontal coordinate of a certain first sub-tile in the respective row of first sub-tiles is greater than the maximum value of the horizontal coordinate of the minimum peripheral rectangular box of the primitive, it indicates that the respective first sub-tile is located outside the minimum peripheral rectangular box of the primitive at a horizontal direction. At this case, it may be directly determined that the respective first sub-tile is not covered by the primitive. If the maximum value of the horizontal coordinate of a certain first sub-tile is greater than or equal to the minimum value of the horizontal coordinate of the minimum peripheral rectangular box of the primitive and the minimum value of the horizontal coordinate of the first sub-tile is less than or equal to the maximum value of the horizontal coordinate of the minimum peripheral rectangular box of the primitive, in some embodiments, it may be directly determined that the respective first sub-tile is covered by the primitive. In this way, the first sub-tile that is obviously not covered by the primitive may be excluded quickly.

In some other embodiments, it may also be detected precisely whether the first sub-tile is covered by a primitive from the first sub-tiles whose horizontal and vertical coordinate ranges partially overlap with the horizontal and vertical coordinate ranges of the minimum peripheral rectangular box of the primitive. The method of continuously detecting whether the first sub-tile is covered by the primitive may be implemented by the manner of determining whether the range of the region occupied by the first sub-tile overlaps with the range of the region occupied by the primitive, or implemented by the manner of sampling the first sub-tile. The specific operations of these two manners have been mentioned above and will not be elaborated here.

In the context of the present disclosure, the terms “row” and “column”, and “horizontal” and “vertical” are used merely to indicate the relative arrangement direction of a tile or sub-tile. For example, the “row” and “column” are two angled directions, and the “horizontal” and “vertical” are also angled directions. However, these terms are not used to limit a specific arrangement direction or an absolute arrangement direction of a tile or sub-tile. The “row” and “column” are a pair of relative arrangements that may be transposed, and the “horizontal” and “vertical” are a pair of relative directions that may be transposed.

The first sub-tile covered by the primitive is a valid first sub-tile, and the data of valid first sub-tile may be input to the sample rasterizer 615 to perform the operation of pixel-level rasterization. For example, the primitive is rasterized by taking pixels in the first sub-tile as a mapping object to determine a first mask for each sample of each pixel of the first sub-tile covered by the primitive (step S515). In this step, the sample rasterizer 615 sequentially rasterizes each primitive in the valid first sub-tile, determines a first mask for each sample of each pixel of the first sub-tile, and then transmits the first sub-tile for which the first masks of the samples of the pixels have been determined to the pixel quad generator for subsequent operation. For a first sub-tile that is not covered by a primitive, in some embodiments, a preset mask may be assigned to the samples of each pixel of such first sub-tile. With such a configuration, the operation of pixel-level rasterization is essentially performed only on the valid first sub-tile, and is not performed on the first sub-tile that is not covered by the primitive, such that a large amount of computing resources may be saved and invalid processing is avoid.

At the tile recombiner, the first sub-tiles for which the first masks of samples of pixels have been determined are combined to form a rasterized tile (step 519). Then, at the pixel quad generator, the pixel quad data is determined based on the rasterized tile (step S520). The pixel quad data generated according to the above steps includes the first masks of the samples of pixels. The pixel quad that includes the first masks may be transmitted to the shader in a subsequent pipeline to complete the rendering for the tile. A pixel quad refers to 2×2 pixels, which is the smallest unit of pixel shading. That is, even if only one pixel in a pixel quad is covered by a primitive, all four pixels in a pixel quad need to be pixel shaded.

In the rasterization method according to the embodiments of the present disclosure, the tile is further partitioned into first sub-tiles, and the size is reduced, so that the on-chip buffer is capable of accommodating the data of the first sub-tile used and generated in the back end pipeline. In this way, the size and sampling rate of the tiles will not be limited by the capacity size of the on-chip buffer. Compared with the conventional tile-based image rendering method, the embodiments of the present disclosure allow the size of the tile to be flexibly adjusted according to the actual application requirements. For example, it may be significantly larger, so that the number of tiles partitioned from the screen space is less, the burden of the tile partitioning operation is reduced, and the data amount of the primitive list is reduced, thereby alleviating the read/write bandwidth pressure of the memory.

In the related art, the sampling rate for rasterizing and the target sampling rate for shading are bound. That is, the number of samples in a pixel for the pixel rasterization is the same as the number of times the pixel is shaded. In the present disclosure, the embodiments of the present disclosure allow a higher sampling rate in pixel rasterization, and it is completed at a lower target sampling rate in subsequent pixel shading. Therefore, in the present disclosure, the sampling rate for rasterizing and the target sampling rate for shading may be separately set. In particular, the sampling rate for rasterizing may be set higher to improve the antialiasing effect. For the tiles with constant size, even if the number of samples increases, the storage in the on-chip buffer will not be affected. Furthermore, the target sampling rate may be set lower to reduce the amount of calculation and the data blocking rate in the shading phase.

In some embodiments, the process of extracting the pixel quad may be to extract the pixel quad directly from the first sub-tile for which the pixel rasterization is completed. FIG. 7 schematically illustrates a process from the tile to the pixel quadruple according to an embodiment of the present disclosure. As illustrated in FIG. 7, the tile 705 is divided into a plurality of first sub-tiles 710 after being processed by the tile parser. Then the operations of the sub-tile rasterizer and the sample rasterizer are performed on the first sub-tile 710 first to complete the rasterization for its pixels, and then it may be directly input to the pixel quad packer 630 to extract the pixel quad 715 from the first sub-tile for which the pixel rasterizing is completed.

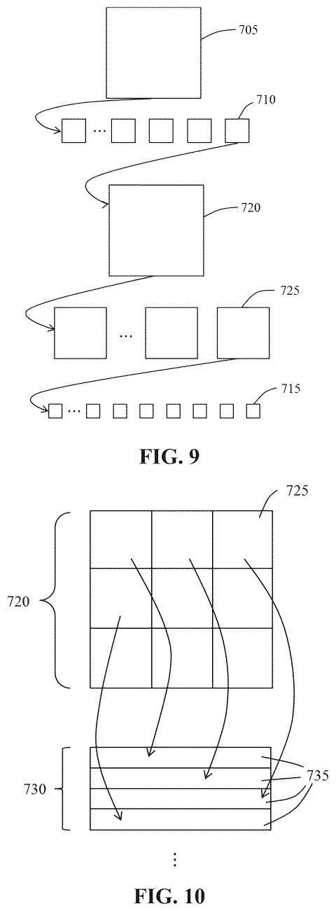

In some other embodiments, the process of extracting the pixel quad may include recombining and re-decomposing the first sub-tile based on the capacity of the on-chip color buffer. For example, first, a number of color data stored for a pixel and a number of samples of the pixel are determined. Then, in response to the number of color data stored for the pixel being less than the number of samples of the pixel, the rasterized tile is partitioned into a plurality of second sub-tiles based on a capacity of an on-chip color buffer of a graphics processor. For example, if the pixel shader is set to perform under MSAA1X condition (that is, one color is stored for a pixel (shading once)), and the sampling rate of the pixel is performed under the standard of MSAA2X or higher (that is, the number of samples of a pixel is 2 or more), the rasterized tile is partitioned into a plurality of second sub-tiles. Next, a pixel quad is extracted from the second sub-tiles with a pixel quad packer 630. FIG. 8 schematically illustrates a flowchart of a tile-based rasterization method according to an embodiment of the present disclosure. FIG. 9 schematically illustrates a process from the tile to the pixel quadruple according to an embodiment of the present disclosure. As illustrated in FIG. 8 and FIG. 9, the tile 705 is partitioned into the first sub-tiles 710 first, then it is determined whether each first sub-tile 710 is covered by a primitive, and it is detected whether this process is completed for each first sub-tile. If the operation that it is determined whether a first sub-tile is covered by a primitive is not completed for all first sub-tiles, the process continues. If the operation that it is determined whether a first sub-tile is covered by a primitive is completed for all first sub-tiles, a mask for each sample of each pixel for the first sub-tile covered by the primitive is determined, that is, the samples of pixel are rasterized, and it is detected whether this process is completed for all first sub-tile covered by the primitive. If the process has not been completed for all first sub-tiles covered by the primitive, the process continues. If the process is completed for each of the first sub-tiles covered by the primitive, the first sub-tiles are recombined by the tile recombiner 620 after rasterizing the samples of pixels, the size of the obtained recombined rasterized tile 720 is same as the size of the initial unrasterized tile, but the obtained recombined rasterized tile 720 further includes the first masks of the samples of the pixels obtained by rasterizing samples. The rasterized tile 720 is then partitioned into the second sub-tiles 725 by a tile repartitioner 625. The process of partitioning the rasterized tile 720 into the second sub-tiles 725 may be based on the capacity of the on-chip color buffer 730. For example, a single bank 735 of the on-chip color buffer 730 is enabled to accommodate at least one second sub-tile. FIG. 10 schematically illustrates a process of partitioning the rasterized tile 720 into the second sub-tiles 725 and storing the second sub-tiles to banks 735 of an on-chip color buffer 730. As illustrated in FIG. 10, the rasterized tile 720 is partitioned into a plurality of second sub-tiles 725 according to the capacity of the on-chip buffer, and the size of the second sub-tiles 725 is adapted to the capacity of a bank 735 of the on-chip color buffer 730. For example, the size of the rasterized tile 720 may exceed the limit of the capacity of the bank 735 of the on-chip color buffer 730, however, the second sub-tile 725 does not exceed the limit. Therefore, the size of the tile 705 and the number of samples of a pixel may not be limited by the capacity of the on-chip color buffer, and the tile may have a greater size (e.g., greater than the capacity of the color buffer), such that the data throughput requirements for rasterization may be met. In this way, it may enable the rasterization stage to process the tiles with high sampling rate without affecting the storage of color data for the output merging stage. In some other embodiments, if the number of color data stored for the pixel is equal to the number of samples of the pixel, for example, the pixel shader performs in a case of MSAA1X, and the sampling rate of the pixel is also performed in a case of MSAA1X, the rasterized tile may not be partitioned into the second sub-tiles, but the pixel quad 715 data may be extracted directly from the data information of the first sub-tiles.

In the process of partitioning the rasterized tile into the second sub-tiles, the case of misalignment may occur. For example, the size (including the length and width) of the rasterized tile is not necessarily an integral multiple of the preset size (including the preset length and the preset width) of the second sub-tiles. At this case, when partitioning is performed, the actual size of the second sub-tile at the end of the row and/or column is less than the size of other second sub-tiles whose size is a preset size. In some embodiments, if the size of a second sub-tile is less than or equal to half of the preset size, one bank may store two or more such second sub-tiles. In this way, the utilization rate of the bank may be improved. In a specific example, in order to partition the rasterized tile into a plurality of second sub-tiles, a preset size of the second sub-tile is first determined based on the capacity of the on-chip color buffer of the graphics processor. The preset size enables a single bank of the on-chip color buffer to store data of at least one second sub-tile. When the rasterized tile is partitioned into a plurality of second sub-tiles, first, the second sub-tile is obtained along a row direction and a column direction according to the preset size of the second sub-tile. Then it is determined whether an actual size of a second sub-tile at the edge of the row and/or the column is less than or equal to one-half of the preset size. If the actual size of the second sub-tile located at the edge of the row and/or the column is less than or equal to one-half of the preset size of the second sub-tile, at least two second sub-tiles at the edge are stored in the same memory block.

According to another aspect of the present disclosure, a method for image rendering is provided. FIG. 11 schematically illustrates a flow chart of an image rendering method according to an embodiment of the present disclosure. The method includes a front end and a back end. At the front end, first, after obtaining the geometric data of the scene to be rendered, the vertex shader is used to perform vertex processing on the scene to be rendered to obtain the primitive data of the scene to be rendered. The vertexes are generated according to an object in the scene to be rendered, and the primitive data is obtained by converting the vertexes by the vertex shader. The vertex shader may be programmed to transform the vertex coordinate from an object-based coordinate system (object space) to a coordinate system based on a world space or a standardized (normalized) device coordinate space to obtain a transformed vertex coordinate. Through the conversion of the coordinate system, the object space coordinate system used to mark the vertex position of the object when the scene is divided into objects may be converted to illustrate the position of the rendered object in the real world or in the screen of the display device. Then the primitive data may be determined based on the transformed vertex coordinate. Then, the tile partitioner partitions the screen space for displaying the image of the scene to be rendered to obtain tile data. The tile data includes the vertex coordinates of each tile. Next, the tile partitioner determines a list of primitive data for a tile based on the primitive data and the tile data, and stores the list of primitive data to a system memory.

At the back end of the method, the list of primitive data is first extracted from the system memory, and then the tile-based rasterization method according to any embodiment of the present disclosure is performed on each tile based on the list of primitive data to obtain the pixel quad data. Then the pixels are shaded based on the pixel quad to obtain the color data for each tile. First, a sample coverage ratio of a pixel is determined based on the pixel quad. The sample coverage ratio refers to a proportion of the number of samples in a pixel covered by the primitive out of the total number of samples in the pixel. The color data is then stored for the pixel based on the sample coverage ratio. For example, the color data of a pixel is determined by outputting the primitive color in a hierarchical manner based on the color of the primitive and the sample point coverage ratio. This reduces the number of operations for pixel shading. In a case where the number of samples of a pixel is the first number and the number of color data stored for a pixel is the second number when performing rendering, the first number and the second number may be set independently from each other. In particular, in some embodiments, the first number may be greater than the second number. That is, the sampling rate for pixel rasterization is high and the target sampling rate for shading is low, so that the effect of improving the antialiasing effect, reducing the calculation amount and the data blocking rate in the shading stage, and improving the rendering speed may be implement. The color data of a tile may be determined based on the color data of each pixel. Then the color data of each tile is stored into a system memory. Then the color data of the tiles in the system memory are merged to obtain a rendered image.

The image rendering method according to the embodiments of the present disclosure includes the tile-based rasterization method according to the embodiments of the present disclosure. In the tile-based rasterization method, since a tile is partitioned into the first sub-tiles, and in some embodiments, the rasterized first sub-tiles are recombined into a rasterized tile and the rasterized tile is further partitioned into the second sub-tiles, the size of the on-chip buffer is no longer a key factor for setting the tile size and sampling rate. Further, as illustrated in FIG. 11, the image rendering method in the embodiments of the present disclosure does not include a depth buffer, as the tile-based rasterization method in the present disclosure enables high-precision rasterization, which may address the problem of depth processing to a certain extent. Because the depth buffer is no longer used, the tile partitioning stage will not be limited by the on-chip depth buffer, and even the increase of the number of samples does not result in difficulty in tile storage. From another point of view, the present disclosure is particularly applicable to a 2D scene, for which an excellent antialiasing effect may be implemented while enabling a low computational amount. In the image rendering method according to the embodiments of the present disclosure, when the screen space is partitioned by the tile partitioner, the size of a tile and the number of tiles may be flexibly adjusted according to the actual application requirements, such that the size of the primitive list is reduced, the required read and write memory bandwidth is reduced, the pipeline utilization rate is improved, and the problem of overload of the pipeline caused by multi-sampling is alleviated. The image rendering method may implement high sampling rate for rasterization and low sampling rate for shading, thereby implementing simple and efficient antialiasing.

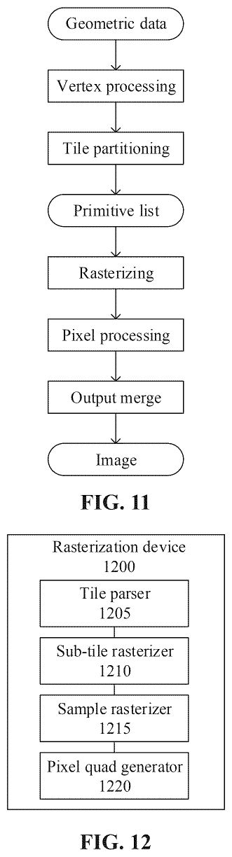

According to another aspect of the present disclosure, a tile-based rasterization device is further provided. FIG. 12 schematically illustrates a block diagram of a tile-based rasterization device according to an embodiment of the present disclosure. As illustrated in FIG. 12, the rasterization device 1200 includes: a tile parser 1205, a sub-tile rasterizer 1210, a sample rasterizer 1215, and a pixel quad generator 1220. The tile parser 1205 is configured to partition a tile into a plurality of first sub-tiles, herein the tile is obtained by partitioning a screen space for displaying an image of a scene to be rendered. The sub-tile rasterizer 1210 is configured to determine whether each of the plurality of first sub-tiles is covered by a primitive, herein the primitive is obtained by performing vertex processing on the scene to be rendered. The sample rasterizer 1215 is configured to: in response to the first sub-tile being covered by the primitive, rasterize the primitive by using pixels in the first sub-tile covered by the primitive as a mapping object to determine a first mask for each sample of each pixel of the first sub-tile covered by the primitive. The pixel quad generator 1220 is configured to extract pixel quad data from the first sub-tile for which the masks of the samples of the pixels have been determined, herein the pixel quad data includes the first mask. In some embodiments, the sub-tile rasterizer is further configured to: in response to the first sub-tile being not covered by the primitive, assign a preset first mask to samples of each pixel of the first sub-tile.

In some embodiments, the pixel quad generator includes: a tile recombiner, a tile repartitioner, and a pixel quad packer. The tile recombiner is configured to combine first sub-tiles for which first masks of samples of pixels have been determined to form a rasterized tile. The tile repartitioner is configured to partition the rasterized tile into the plurality of second sub-tiles based on the capacity of the on-chip color buffer of the graphics processor. The pixel quad packer is configured to extract the pixel quad data from the second sub-tiles.

In some embodiments, the sub-tile rasterizer, which is configured to determine whether each of the plurality of first sub-tiles is covered by the primitive, is further configured to: determine whether there is at least one line of vertexes of the primitive passing through a region defined by the vertex coordinates of a first sub-tile based on the vertex coordinates of the first sub-tile and the vertex coordinates of the primitive; in response to at least one line of vertexes of the primitive passing through the region defined by vertex coordinates of the first sub-tile, determine that the first sub-tile is covered by the primitive. In some other embodiments, the sub-tile rasterizer, which is configured to determine whether each first sub-tile is covered by the primitive, is further configured to: sample sub-tile samples of a first sub-tile to determine a second mask of the first sub-tile; and determine whether the first sub-tile is covered by the primitive based on the second mask of the first sub-tile.

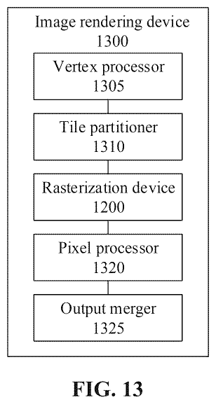

According to another aspect of the present disclosure, it is further provided an image rendering device. FIG. 13 schematically illustrates a block diagram of an image rendering device 1300 according to an embodiment of the present disclosure. The image rendering device 1300 includes a vertex processor 1305, a tile partitioner 1310, a tile-based rasterization device 1200 according to any embodiment of the present disclosure, a pixel processor 1320, and an output merger 1325. The vertex processor 1305 is configured to perform vertex processing on a scene to be rendered to obtain primitive data of the scene to be rendered. The tile partitioner 1310 is configured to: partition a screen space for displaying an image of the scene to be rendered to obtain tile data; and determine a primitive list for respective tiles based on the primitive data and the tile data. The rasterization device 1200 is configured to generate a pixel quadruple (pixel quad) based on the primitive list. The pixel processor 1320 is configured to: determine a sample coverage ratio of a pixel based on the pixel quad; store a first number of color data for the pixel based on the sample coverage ratio; and store color data for pixels of each tile into a system memory; herein a number of samples of the pixel is a second number, and the first number and the second number are set independently. The output merger 1325 is configured to merge the color data of respective tiles in the system memory to obtain a rendered image.

According to the tile-based rasterization device and the image rendering device according to the embodiments of the present disclosure, the tile-based rasterization method and the image rendering method according to the present disclosure may be implemented, and the effects that may be implemented by the above-described methods may be obtained, and it will not be elaborated herein.

Various devices, apparatus, and other components related to the present disclosure may be implemented by hardware components. The examples of hardware components include controller, memory, driver, comparator, arithmetic logic unit, adder, subtractor, multiplier, divider, integrator, and any other electronic components well known to those of ordinary skill in the art. In an example, the hardware components are implemented by one or more processing devices or processors. The processing device or the processor may include one or more processing elements, such as a logic gate array, a controller and an arithmetic logic unit, a digital signal processor, a microcomputer, a programmable logic controller, a field programmable gate array, a programmable logic array, a microprocessor, or any other device or combination of devices well known to one of ordinary skill in the art. These devices or combinations of devices are capable of responding to and executing instructions in a defined manner to obtain a desired result. The processing device or processor includes or is connected to one or more memories, and the memory is configured to store code, instruction, or software executed by the processing device or processor.

The specific embodiments illustrated and described herein are illustrative examples and do not limit the scope of the present disclosure in any way. Furthermore, the connecting lines or connectors illustrated in the various accompanying drawings are intended to represent exemplary functional relationship and/or physical or logical connection between various elements. It is to be noted that a plurality of alternative or additional functional relationships, physical connections, or logical connections may exist in the actual device.

The terminologies used herein are merely for the purpose of explaining specific embodiments and are not intended to be limiting. The singular form includes the plural form except that the two forms differ from each other in context. For example, as used herein, the singular form is intended to include the plural form as well unless the context clearly dictates otherwise. The terms “comprising” or “including” should be understood not to preclude in advance the existence or additional possibility of one or more other characteristics, shapes, operations, components, elements, or combinations thereof. In addition, the terms including an ordinal number such as “first”, “second”, etc. are used for convenience in describing various elements or distinguishing various elements. However, these elements should not be limited by these terms and are not intended to indicate the order or order of requirements unless they have different meanings in context. Unless otherwise indicated, the steps of all methods described herein may be performed in any suitable order.

### INDUSTRIAL PRACTICALITY

The technical solutions of the embodiments of the present disclosure may be applied to a rasterization method and device and an image rendering method and device for a mobile-level GPU. According to the technical solutions provided by the embodiments of the present disclosure, the size of the tile and the sampling rate for pixel rasterization may be flexibly set without being limited by the capacity of the on-chip memory, and the number of tiles may be reduced, thereby reducing the load of the tile partitioning operation, alleviating the blockage of the pipeline, and implementing an excellent antialiasing effect in a simple and efficient manner.

1. A method for tile-based rasterization, comprising:
partitioning a tile into a plurality of first sub-tiles, wherein the tile is obtained by partitioning a screen space for displaying an image of a scene to be rendered;
determining whether each of the plurality of first sub-tiles is covered by a primitive, wherein the primitive is obtained by performing vertex processing on the scene to be rendered;
in response to the first sub-tile being covered by the primitive, rasterizing the primitive by using pixels in the first sub-tile covered by the primitive as a mapping object, to determine a first mask for each sample of each pixel of the first sub-tile covered by the primitive;
combining first sub-tiles for which first masks of samples of pixels have been determined to form a rasterized tile; and
determining pixel quad data based on the rasterized tile, wherein the pixel quad data comprises the first mask.

2. The method for rasterization of claim 1, wherein determining the pixel quad data based on the rasterized tile comprises:
determining a number of color data stored for a pixel and a number of samples of the pixel;
in response to the number of color data stored for the pixel being less than the number of samples of the pixel, partitioning the rasterized tile into a plurality of second sub-tiles based on a capacity of an on-chip color buffer of a graphics processor; and
extracting the pixel quad data from data information of the second sub-tiles.

3. The method for rasterization of claim 2, wherein determining the pixel quad data based on the rasterized tile further comprises:
in response to the number of color data stored for the pixel being equal to the number of samples of the pixel, extracting the pixel quad data from data information of the first sub-tiles.

4. The method for rasterization of claim 2, wherein partitioning the rasterized tile into the plurality of second sub-tiles based on the capacity of the on-chip color buffer of the graphics processor comprises:
determining a preset size of the second sub-tiles based on the capacity of the on-chip color buffer of the graphics processor; and
obtaining the second sub-tiles on the rasterized tile along a row direction and a column direction according to the preset size of the second sub-tiles.

5. The method for rasterization of claim 4, wherein the on-chip color buffer comprises a plurality of banks, and partitioning the rasterized tile into the plurality of second sub-tiles based on the capacity of the on-chip color buffer of the graphics processor further comprises:
determining whether an actual size of a second sub-tile at an edge of at least one of a row or a column is less than or equal to one-half of the preset size; and
in response to the actual size of the second sub-tile at the edge being less than or equal to one-half of the preset size, storing at least two second sub-tiles at the edge in a single bank.

6. The method for rasterization of claim 1, wherein determining whether each of the plurality of first sub-tiles is covered by the primitive comprises:
determining a vertical coordinate range of a minimum peripheral rectangular box surrounding the primitive;
determining, row by row, whether a vertical coordinate range of each row of first sub-tiles at least partially overlaps with the vertical coordinate range of the minimum peripheral rectangular box; and
in response to a vertical coordinate range of a row of first sub-tiles does not at least partially overlap with the vertical coordinate range of the minimum peripheral rectangular box, determining that first sub-tiles in the row of first sub-tiles are not covered by the primitive.

7. The method for rasterization of claim 6, wherein determining whether each of the plurality of first sub-tiles is covered by the primitive further comprises:
determining a horizontal coordinate range of the minimum peripheral rectangular box surrounding the primitive;
in response to a vertical coordinate range of a row of first sub-tiles at least partially overlaps with the vertical coordinate range of the minimum peripheral rectangular box, determining, one by one, whether a horizontal coordinate range of each first sub-tile in the row of first sub-tiles at least partially overlaps with the horizontal coordinate range of the minimum peripheral rectangular box; and
in response to the horizontal coordinate range of the first sub-tile in the row of first sub-tiles does not at least partially overlap with the horizontal coordinate range of the minimum peripheral rectangular box, determining that the first sub-tile is not covered by the primitive.

8. The method for rasterization of claim 1, wherein determining whether each of the plurality of first sub-tiles is covered by the primitive comprises:
determining whether a region defined by vertex coordinates of the primitive at least partially overlaps with a region defined by a horizontal coordinate range and a vertical coordinate range of a first sub-tile; and
in response to the region defined by the vertex coordinates of the primitive at least partially overlaps with the region defined by the horizontal coordinate range and the vertical coordinate range of the first sub-tile, determining that the first sub-tile is covered by the primitive.

9. The method for rasterization of claim 1, wherein determining whether each of the plurality of first sub-tiles is covered by the primitive comprises:
sampling sub-tile samples of the first sub-tile to determine a second mask of the first sub-tile; and
determining whether the first sub-tile is covered by the primitive based on the second mask of the first sub-tile.

10. The method for rasterization of claim 1, further comprising: in response to the first sub-tile being not covered by the primitive, assigning a preset first mask to samples of pixels of the first sub-tile.

11. A method for image rendering, comprising:
performing vertex processing on a scene to be rendered to obtain primitive data of the scene to be rendered;
partitioning a screen space for displaying an image of the scene to be rendered to obtain tile data;
determining a primitive list for respective tiles based on the primitive data and the tile data;
obtaining the pixel quad data by performing the method for tile-based rasterization of claim 1 on each tile based on the primitive list;
determining a sample coverage ratio of a pixel based on the pixel quad data;
storing a first number of color data for the pixel based on the sample coverage ratio, wherein a number of samples of the pixel is a second number, and the first number and the second number are set independently;
storing color data for pixels of each tile into a system memory; and
merging the color data of respective tiles in the system memory to obtain a rendered image.

12. The method for image rendering of claim 11, wherein performing vertex processing on the scene to be rendered to obtain the primitive data of the scene to be rendered comprises:
determining a vertex coordinate of an object in the scene to be rendered;
transforming the vertex coordinate from an object-based coordinate system to a coordinate system based on a world space or a normalized device coordinate space to obtain a transformed vertex coordinate; and
determining the primitive data based on the transformed vertex coordinate.

13. A device for tile-based rasterization, comprising:
a tile parser, configured to partition a tile into a plurality of first sub-tiles, wherein the tile is obtained by partitioning a screen space for displaying an image of a scene to be rendered;
a sub-tile rasterizer, configured to determine whether each of the plurality of first sub-tiles is covered by a primitive, wherein the primitive is obtained by performing vertex processing on the scene to be rendered;
a sample rasterizer, configured to: in response to the first sub-tile being covered by the primitive, rasterize the primitive by using pixels in the first sub-tile covered by the primitive as a mapping object to determine a first mask for each sample of each pixel of the first sub-tile covered by the primitive;
a tile recombiner, configured to combine first sub-tiles for which first masks of samples of pixels have been determined to form a rasterized tile; and
a pixel quad generator, configured to determine pixel quad data based on the rasterized tile, wherein the pixel quad data comprises the first mask.

14. The device for rasterization of claim 13, wherein the pixel quad generator comprises a tile repartitioner and a pixel quad packer, wherein
the tile repartitioner is configured to: determine a number of color data stored for a pixel and a number of samples of the pixel; and in response to the number of color data stored for the pixel being less than the number of samples of the pixel, partition the rasterized tile into a plurality of second sub-tiles based on a capacity of an on-chip color buffer of a graphics processor; and
the pixel quad packer is configured to extract the pixel quad data from data information of the second sub-tiles.

15. The device for rasterization of claim 14, wherein the tile repartitioner is further configured to: in response to the number of color data stored for the pixel being equal to the number of samples of the pixel, extract the pixel quad data from data information of the first sub-tiles.

16. The device for rasterization of claim 14, wherein the tile repartitioner, which is configured to partition the rasterized tile into the plurality of second sub-tiles based on the capacity of the on-chip color buffer of the graphics processor, is further configured to:
determine a preset size of the second sub-tiles based on the capacity of the on-chip color buffer of the graphics processor; and
obtain the second sub-tiles on the rasterized tile along a row direction and a column direction according to the preset size of the second sub-tiles.

17. (canceled)

18. The device for rasterization of claim 13, wherein the sub-tile rasterizer, which is configured to determine whether each of the plurality of first sub-tiles is covered by the primitive, is further configured to: determine a vertical coordinate range of a minimum peripheral rectangular box surrounding the primitive;
determine, row by row, whether a vertical coordinate range of each row of first sub-tiles at least partially overlaps with the vertical coordinate range of the minimum peripheral rectangular box; and
in response to a vertical coordinate range of a row of first sub-tiles does not at least partially overlap with the vertical coordinate range of the minimum peripheral rectangular box, determine that first sub-tiles in the row of first sub-tiles are not covered by the primitive.

19-21. (canceled)

22. The device for rasterization of claim 13, the sub-tile rasterizer is further configured to: in response to the first sub-tile being not covered by the primitive, assign a preset first mask to samples of pixels of the first sub-tile.

23. A device for image rendering, comprising:
a vertex processor, configured to perform vertex processing on a scene to be rendered to obtain primitive data of the scene to be rendered;
a tile partitioner, configured to: partition a screen space for displaying an image of the scene to be rendered to obtain tile data; and determine a primitive list for respective tiles based on the primitive data and the tile data;
the device for tile-based rasterization of claim 13, the device for tile-based rasterization is configured to determine the pixel quad data based on the primitive list;
a pixel processor, configured to determine a sample coverage ratio of a pixel based on the pixel quad data; store a first number of color data for the pixel based on the sample coverage ratio; and store color data of each tile into a system memory; wherein a number of samples of the pixel is a second number, and the first number and the second number are set independently; and
an output merger, configured to merge the color data of respective tiles in the system memory to obtain a rendered image.

24. The device for image rendering of claim 23, wherein the vertex processor is further configured to:
determine a vertex coordinate of an object in the scene to be rendered;
transform the vertex coordinate from an object-based coordinate system to a coordinate system based on a world space or a normalized device coordinate space to obtain a transformed vertex coordinate; and
determine the primitive data based on the transformed vertex coordinate.
